(19) United States
(12) Patent Application Publication
(10) Pub. No.: US 2011/0276193 A1
(43) Pub. Date: Nov. 10, 2011

(54) ENERGY EFFICIENT LIGHTING SYSTEM

(75) Inventors: Brian T. Bowman, Escondido, CA (US); James A. Erickson, Lincoln, NE (US)

(73) Assignee: Green Ballast Inc., Memphis, TN (US)

(21) Appl. No.: 13/099,911

(22) Filed: May 3, 2011

Related U.S. Application Data
(60) Provisional application No. 61/331,379, filed on May 4, 2010.

(51) Int. Cl. G06F 1/32

(52) U.S. Cl. 700/295

(57) ABSTRACT

The present invention relates to an energy efficient lighting system, more particularly a system and method for controlling the individual power consumption and light output for each lighting luminary at a local level based upon a multitude of inputs whereby at least one of the inputs preferably is from central building control. Preferably, the ballast or lighting fixture is operatively associated with and preferably includes a microcontroller that processes all signals from sensors and other control devices including a building central control sensor that manages building power consumption and selects the most energy efficient input signal to power the lamps. The lighting system preferably includes a plurality of lighting fixtures and the lighting output of each fixture is determined on the local level by the microcontroller associated with and preferably in each circuit housing or ballast associated with the fixture.

### CROSS REFERENCE TO RELATED APPLICATION

This application claims the benefit of U.S. Provisional Application No. 61/331,379 filed May 4, 2010, the entire content of which is incorporated herein by reference thereto.

### FIELD OF THE INVENTION

The present invention relates to an energy efficient lighting system, more particularly a system and method for controlling the individual power consumption and light output for each lighting luminary at a local level based upon a multitude of inputs preferably whereby at least one of the inputs preferably is from central building control.

### BACKGROUND OF THE INVENTION

Energy conservation and management in large buildings is very important. In many buildings, control and monitoring of lighting systems is performed by a central building command or control. The central building command, which operates the lighting system, is often located remotely from the individual lighting fixtures or luminaries, and may even be located off-site from the building being controlled.

There are a number of lighting systems that utilize photo sensors and occupancy sensors to control the lighting in buildings. For example, some buildings have occupancy sensors to detect whether or not occupants are located in a room and which turn off the lights when no one is present in the room for a period of time. Other systems may utilize photo sensors to dim lighting fixtures in a room depending upon the brightness in the room as detected by the photo sensors. One example of a lighting system utilizing photo sensors is U.S. Pat. No. 6,969,955, the entire contents of which are incorporated herein by reference. Other systems may rely upon timed programs to control the lighting in buildings and other systems may rely upon a combination of occupancy sensors, timed programs, photo sensors or building centralized command centers to control and monitor the lighting system in buildings. These existing control systems however are complex and expensive. In addition, these systems usually are centrally controlled. It is desirable for a lighting system to be relatively inexpensive, easy and simple to install and operate, and which provides maximum energy efficiency.

### BRIEF SUMMARY OF THE INVENTION

The present invention relates generally to an energy efficient lighting system. More specifically, a preferred embodiment of the present invention relates to a system and method for controlling the individual power consumption and light output of each lighting luminary at a local level based upon a multitude of inputs whereby at least one of the inputs preferably is from building central control or command. The lighting system preferably has one or more lighting fixtures, each lighting fixture preferably independently controlled at the lighting fixture. Preferably, a microcontroller in a microcontroller circuit is operatively associated with, proximate to and preferably in the housing of the lighting fixture with the lamps and processes all input signals from sensors and other control devices, and determines the power output to, and hence the amount of lighting provided by the lamps and lighting fixture. The microcontroller or microprocessor may be in a housing module separate from the light fixture housing (with the lamps). Preferably the input signals from the sensors and other control inputs are processed at the local level by the microcontroller, and independent of the other lighting fixtures, to use the lowest power consumption. The microcontroller preferably receives all the control signal inputs and filters or otherwise processes them to permit the input signal that provides for the lowest power level output to the lamps to control the operation of the lamp driving circuit.

The microcontroller preferably sends a control signal to a lamp driving circuit which may be a voltage level that corresponds to the input signal that provides for the lowest level of lighting and hence the most energy efficient operation of the lamp driving circuit and lighting fixture. There may be one microcontroller per lighting fixture, which may provide control signals to one or more lamp driving circuits, or multiple microcontrollers per lighting fixture with each microcontroller providing a control signal to one lamp driving circuit. The number of microcontrollers and lamp driving circuits typically depends upon the size and number of lamps in the lighting fixture.

The control inputs to the microcontroller may optionally include one or more of the following: a photo sensor input to control power output of the lighting fixture based upon the ambient lighting conditions at the lighting fixture and/or the area that the lighting fixture is designed to illuminate; a wall dimmer to manually control the light output; an occupancy sensor to control the on/off function of the lighting fixture; and control inputs from building central control or command. The operation, function and use of these different control inputs will be described in more detail below.

In one embodiment a lighting system for providing dimming control to at least one lighting fixture having at least one lamp is provided. While the lighting system and control have been described with reference to lighting fixtures, lamps and bulbs, it should be understood that the term lamp(s) or bulb(s) is used in its broadest sense and may include one or more incandescent bulbs, florescent bulbs, Xeon bulbs or lights, halogen lights, sodium lights, discharge bulbs or lights, and Light Emitting Diodes (LEDs). The lighting system comprises a microcontroller circuit having a microcontroller for processing a plurality of input control signals, the microcontroller circuit transmitting an output voltage control signal to a lamp driving circuit electrically connected to the microcontroller circuit. The lamp driving circuit receives the voltage control signal transmitted by the microcontroller circuit and is connectable to the at least one lamp. The lamp driving circuit is responsive to the microcontroller voltage control signal to provide varying power output to the at least one lamp based upon the voltage control signal received from the microcontroller circuit. The lighting system may further include a power supply circuit for supplying power to the microcontroller circuit and the lamp driving circuit. The microcontroller preferably is programmed and configured to process the plurality of input control signals and determine the output voltage control signal and transmit the same to the lamp driving circuit based upon the input control signal that would supply the lowest power output to the at least one lamp.

The light dimming control system may further comprise a least one external communication interfacing device to facilitate communication with the microcontroller circuit, the interfacing device adapted to provide at least one input control signal to the microcontroller circuit that is external to the microcontroller circuit. The communication-interfacing device may comprise a module that sends signals to the microcontroller circuit over the power lines to the lighting fixture, a wireless receiver for receiving signals or a wireless transreceiver for transmitting and receiving signals.

The light dimming control system may further comprise at least one light sensor operatively connected to the microcontroller circuit. The light sensor may comprise a phototransistor. The control input signals may comprise at least one of the group including a tuning function input signal, a manual dimming input signal, a demand response function input signal, a first light sensor input signal, a second light sensor input signal, an occupancy sensor, an adaptive eye function input signal, a maintenance function input signal, a voluntary user reduction function input signal and an on-off input signal. The microcontroller may in one embodiment be programmed to provide a fade response to any change in power supplied to the at least one lamp. The microprocessor may further be programmed so that the fade response does not apply to signals received from a light sensor input, or other input signals if desired.

The light dimming system may further comprise a communication interface device to communicate with a building central command, wherein the microprocessor circuit is configured to receive control signals from building central command, and further wherein the microprocessor circuit is programmed to override control signals from building central command if those signals do not provide the lowest power output to the at least one lamp. The light dimming system may further include a wireless receiver to receive calibration signals from a remote transmitter. The wireless receiver may be an infrared wireless receiver.

The lighting system may further comprise a light sensor connected to the microprocessor circuit and wherein the microcontroller is configured and programmed to adjust the sensitivity of the light sensor by adjusting how the microprocessor responds to the voltage signal received by the light sensor. The calibration signals from the remote transmitter may include signals to adjust the sensitivity of the light sensor. The microcontroller may be configured and programmed to provide a tuning calibration to set the maximum power output to be supplied to the lamps and a wireless receiver connected to the microcontroller circuit is for supplying the microcontroller with the tuning calibration for the lighting fixture. The lighting system may comprise a housing containing the microcontroller circuit, the lamp driving circuit, the power supply circuit and the at least one lamp. Alternatively, the microcontroller circuit and/or the lamp driving circuit may be located in a housing module separate from and preferably external to the lighting fixture where the lamps are located.

In yet another embodiment an electronic ballast system for a florescent lighting fixture is provided. The electronic ballast system may include a microcontroller circuit having a microcontroller, the microcontroller circuit for processing a plurality of input controls including an input control signal from a light sensor and a remote external input control signal from a building central control, the microcontroller circuit electrically connected to and transmitting an output voltage control signal to a high frequency florescent lamp driving circuit. The lamp driving circuit for powering a plurality of florescent lamps, and for receiving and responding to the voltage control signal transmitted by the microcontroller circuit to provide varying power output to the plurality of lamps. A communications module for communicating with building central control for providing the input control signal from building central control to the microcontroller circuit may also be included. The microcontroller preferably is programmed and configured to process the light sensor control signal and the external input control signal from building central control demand and determine the out put voltage control signal and transmit that control signal to the lamp driving circuit based upon the input control signal that would provide the lowest power output to the lamps.

The electronic ballast system may further have a wireless transreceiver, the wireless transreceiver configured and adapted to receive at least one control input signal from building central control and to transmit a signal to at least one of the group of building central control and adjacent ballast systems.

In another embodiment a controller for a lighting system is provided, the controller preferably including a microcontroller circuit having a microcontroller, the microcontroller circuit for processing a plurality of input controls including an input control signal from a light sensor and a remote external input control signal from a building central control, the microcontroller circuit transmitting an output voltage control signal, wherein the microcontroller is programmed and configured to process the light sensor control signal and the external input control signal from building central control and determine the output voltage control signal and transmit that control signal based upon the input control signal that would provide the lowest power output to the lamps. The microcontroller preferably is configured and programmed to process control input signals comprising at least one of the group of a manual dimming input signal, an occupancy sensor input signal, an adaptive input signal, a demand response input signal, a tuning function input signal, a maintenance function input signal, a voluntary user reduction input signal and an on-off input signal and determine the output control signal based upon the input control signal that would provide the lowest power output to the lamps.

Other arrangements, structures, features, embodiments, aspects, instrumentalities, methods and constructions of the lighting system will be evident to those skilled in the art upon review of the detailed description, and the present invention should not be limited to the summary, and/or preferred embodiments shown and described.

### BRIEF DESCRIPTION OF THE SEVERAL VIEWS OF THE DRAWINGS

The foregoing summary, as well as the following detailed description of preferred embodiments of the inventions, will be better understood when read in conjunction with the appended drawings. For the purposes of illustrating the lighting system of the present invention, drawings of preferred embodiments are shown. It should be understood, however, that the application is not limited to the precise arrangements, structures, features, embodiments, aspects, methods and instrumentalities shown, and the arrangements, structures, features, embodiments, aspects, methods and instrumentalities shown may be used singularly or in combination with other arrangements, structures, features, embodiments, aspects, methods and instrumentalities. In the drawings:

FIG. 1 illustrates a block diagram representation of the lighting system in accordance with a first preferred embodiment of the present invention;

FIG. 1a illustrates a block diagram representation of the lighting system in accordance with another embodiment of the invention;

FIG. 2 illustrates a block diagram of the microcontroller inputs in accordance with a preferred embodiment of the present invention;

FIG. 3a illustrates a perspective view of the photo sensor housing in accordance with one embodiment of the present invention;

FIG. 3b illustrates a cross-sectional representation of the photo sensor housing in accordance with one embodiment of the present invention;

FIG. 3c illustrates a front view of a two-piece photo sensor housing in accordance with another embodiment of the present invention;

FIG. 4 illustrates a flow diagram of the microcontroller logic in accordance with one embodiment of the present invention;

FIG. 5 illustrates a block diagram of the lamp control circuit in accordance with one embodiment of the present invention;

FIG. 6 illustrates a representative example of a schematic diagram of the power supply circuit diagrammatically illustrated in FIG. 5 for the lamp system in accordance with one of the preferred embodiments of the present invention;

FIG. 7 illustrates a representative example of a schematic diagram of the power factor correction circuit diagrammatically illustrated in FIG. 5 for the lamp system in accordance with one of the preferred embodiments of the present invention;

FIG. 8 illustrates a representative example of a schematic diagram of the microcontroller power supply circuit diagrammatically illustrated in FIG. 5 for the lamp system in accordance with one of the preferred embodiments of the present invention;

FIG. 9 illustrates a representative example of a schematic diagram of the microcontroller circuit diagrammatically illustrated in FIG. 5 for the lamp system in accordance with one of the preferred embodiments of the present invention;

FIG. 10 illustrates a representative example of a schematic diagram of the ballast circuit diagrammatically illustrated in FIG. 5 for the lamp system in accordance with one of the preferred embodiments of the present invention;

FIG. 11 illustrates a representative example of a schematic diagram of the lamp driving circuit diagrammatically illustrated in FIG. 5 for the lamp system in accordance with one of the preferred embodiments of the present invention;

FIG. 12 illustrates a representative example of a schematic diagram of the ballast circuit diagrammatically illustrated in FIG. 5 for the lamp system in accordance with one of the preferred embodiments of the present invention; and

FIG. 13 illustrates a representative example of a schematic diagram of the lamp driving circuit diagrammatically illustrated in FIG. 5 for the lamp system in accordance with one of the preferred embodiments of the present invention.

### DETAILED DESCRIPTION OF THE INVENTION

Referring now to the various figures of the drawings, a preferred embodiment of the lighting system of the present invention shall be described in detail, where like numerals shall refer to like parts.

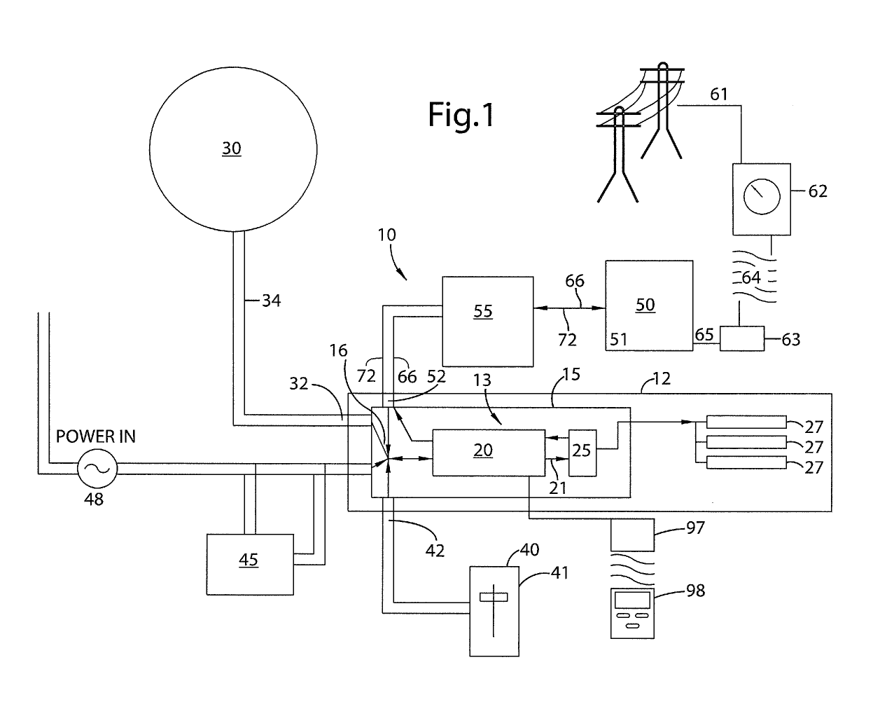

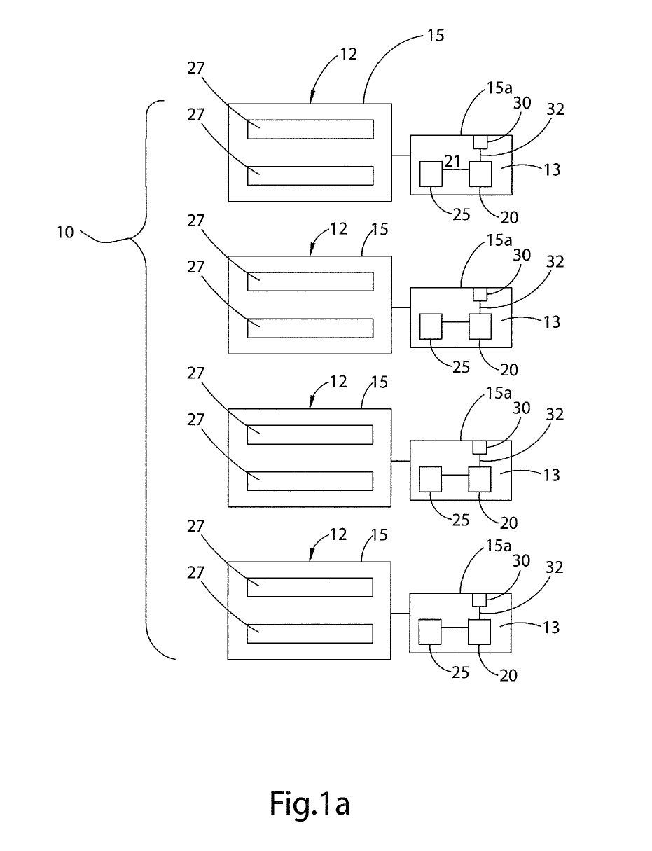

FIG. 1 shows a block diagram representation of the lighting system 10 having a lighting fixture or luminary 12. While FIG. 1 illustrates only one lighting fixture 12, lighting system 10 typically has a plurality of lighting fixtures 12. The lighting fixture 12 has one or more lamps or bulbs 27, a circuit housing 15, control circuitry 13 and a number of control inputs 16. The circuit housing 15 preferably houses the control circuitry 13 which may include microcontroller circuitry 20 including one or more microcontroller central processor(s) 20a (and associated circuitry), and one or more lamp driving circuit(s) 25 for powering or driving one or more lamps 27. While the description has used the terms lighting fixtures, luminaries, lamps, and/or bulbs, it should be understood that these terms are used in their broadest sense (unless more narrowly defined) and may include, but are not limited to, one or more incandescent lights, lamps or bulbs; florescent lights, lamps or bulbs; Xeon lights, lamps or bulbs; halogen lights, lamps or bulbs; sodium lights, lamps or bulbs, discharge lights, lamps or bulbs; Light Emitting Diodes (LEDs) or any other luminary or light emitting device. Lighting fixture 12 typically has from one to eight lamps 27, although more lamps are feasible. The lamp driving circuitry 25 may control one to four lamps 27, and a lighting fixture 12 typically may have one to four lamp driving circuits 25 to supply power to the lamps 27. The microcontroller circuitry 20 and lamp driving circuit 25 are preferably part of circuitry 13 contained in housing 15, although either the microcontroller circuit 20 (and associated microcontrollers 20a) or lamp driving circuit 25 may be in separate modules or housing units 15a (shown in FIG. 1a), and may be separate from the housing 15 and separate from lighting fixture 12. For ease of reference microcontroller 20 will be used herein to refer to the microcontroller 20a and associated circuitry.

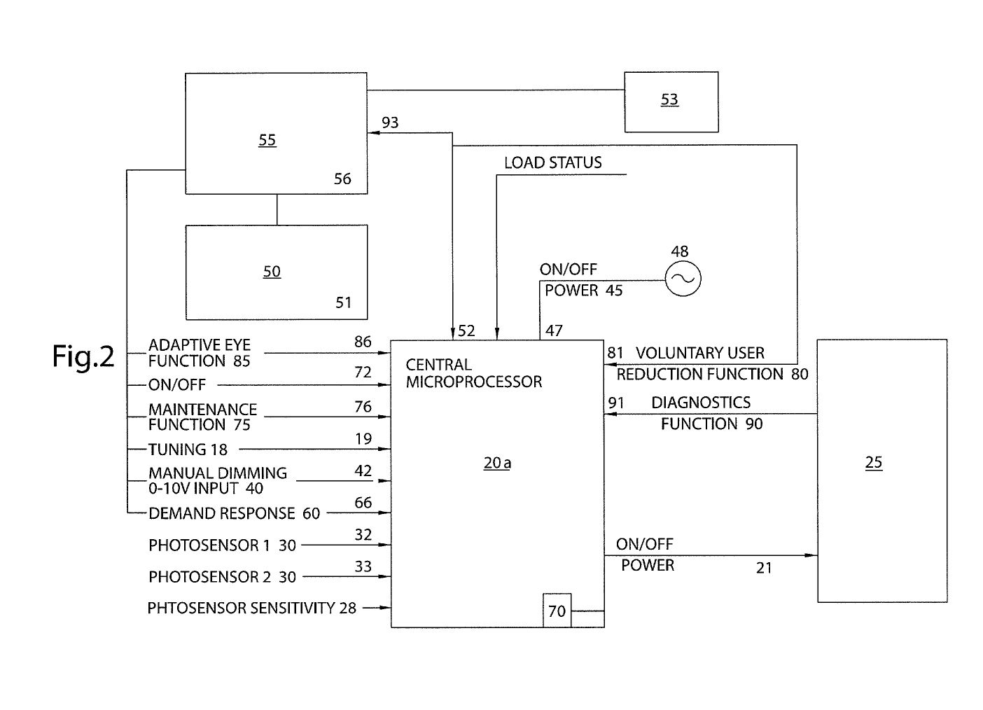

Referring to FIG. 2, preferably the microcontroller 20 will interface with and control the lamp driving circuit 25. Preferably, the microcontroller 20 sends a signal 21 to the lamp driving circuit 25, which indicates the power level that the lamp driving circuit 25 should supply to the lamps 27. More preferably, the lamp driving circuit 25 is a dimmable lamp driving circuit 25 so that the power supplied to the lamps 27 can be varied in order to control the power consumed and the amount of light produced by the lamps 27.

The lighting system 10 has particular application for a fluorescent lighting system where the lamp driving circuit 25 drives florescent lamps 27, and may comprise a florescent lamp ballast driving circuit 25. Although the lighting system 10 of the present invention is described with reference and application to a florescent lighting system, it can be used with other lighting sources including incandescent lights, florescent lights, Xeon lights, halogen lights, sodium lights, discharge lights, Light Emitting Diodes (LEDs) or any other luminary or light emitting device. One exemplary example of a florescent lamp driving circuit 25 may use an integrated circuit (IC) such as the florescent lamp driving integrated circuit sold by International Rectifier as IRS2158D. The lamp driving IC provides power to the lamps 27 based upon the signal received from the microcontroller 20. The microcontroller 20, for example, may supply 0 to 4 volts to the lamp driving circuit 25, which varies the power delivered to the lamps 27 depending upon the value of the voltage supplied by the microcontroller 20 to the driving circuit 25.

In one embodiment of the lighting system 10 of the present invention, each lighting fixture 12 is preferably independently controlled at the lighting fixture 12. Preferably, microcontroller(s) 20 operatively associated with and preferably in the housing 15 processes all input signals 16 and determines the power output to, and hence the amount of lighting provided by, the lamps 27 and lighting fixture 12. The microcontroller(s) 20 may be located in the housing 15, or in a housing module 15a separate from and external to the housing 15 (shown in FIG. 1a), but preferably associated with and more preferably electrically connected to the housing 15. In other embodiments housing module 15a may be wirelessly associated with the lighting fixture housing 15. Preferably the input signals from the sensors and other control inputs described below are processed at the local level by microcontroller 20, and independent of the other lighting fixtures, to use the lowest power consumption. The microcontroller 20 preferably receives all the control signal inputs 16 and filters them to permit the input signal that provides for the lowest power level output to the lamps 27 to control the operation of the lamp driving circuit 25. The microcontroller 20 sends signal 21 to the lamp driving circuit 25 which may be a voltage level that corresponds to the input signal that provided for the lowest level of lighting and hence the most energy efficient operation of the lamp driving circuit 25. There may be one microcontroller 20 per lighting fixture 12 which may provide control signals 21 to one or more lamp driving circuits 25, or multiple microcontrollers 20 per lighting fixture with each microcontroller 20 providing a control signal 21 to one lamp driving circuit 25. The number of microcontrollers 20 and driving circuits 25 typically depends upon the size and number of lamps 27 in the lighting fixture 12.

The control inputs 16 to the microcontroller 20 may optionally include one or more of the following: a photo sensor 30 to control power output of the lighting fixture 12 based upon the ambient lighting conditions at the lighting fixture and/or the area that the lighting fixture 12 is designed to illuminate; a wall dimmer 41 to manually control the light output; an occupancy sensor 45 to control the on/off function of the lighting fixture; and control inputs 52 from building central control or command 50. The operation, function and use of these different control inputs 16 will be described in more detail below.

In one embodiment the lighting system 10 may include a tuning function 18 for each lighting fixture 12 as identified in FIG. 2. The tuning function 18 permits a maximum power output for the lamp driving circuits 25 to be set for each circuit and/or lighting fixture 12. That is the maximum lamp lighting output, and thus the maximum power consumption, can be adjusted for each lighting fixture 12. The primary purpose of tuning the output of the lamps 27 and/or the lighting fixture 12 is to avoid wasting energy by over-lighting a room.

Each lighting fixture 12 is preferably individually tuned for maximum efficiency and flexibility. In one embodiment, the maximum output can be adjusted in ten percent (10%) intervals, for example at 100%, 90%, 80%, 70%, etc, increments. Other setting for the maximum output of the lighting fixture 12 may be in twenty-five percent (25%) increments, (100%, 75%, 50% and 25%). Other maximum output levels or increments are contemplated including a continuously or infinitely adjustable maximum output. The lighting fixture may also be tuned to have a minimum power output, i.e., so the lighting fixture never goes below a certain lighting level. The tuning function 18 may comprise stored programs in microcontroller 20. The stored program may provide a predetermined tuning input signal 19 for the microcontroller 20 to check and compare, such as, for example, a 0 to 10 volt input that corresponds to the maximum threshold power permitted to power the lamps 27. The microcontroller program may, for example, provide a voltage signal that corresponds to a maximum lighting level, or some low power, lower lighting level. Setting the tuning function 18 for the lamp driving circuit 25 and/or the lighting fixture 12 is described in detail below.

In one embodiment the lighting system 10 may include one or more photo or light sensors 30 (also referred to as a day light sensor) to detect the level of light present in the area of the lighting fixture 12. Although FIG. 1 shows one photo sensor 30, more than one photo sensor 30 may be associated with or connected to each light fixture 12, and/or microcontroller 20. The photo sensor 30 preferably is a phototransistor, directly or indirectly, connected to the microcontroller 20. One representative example of a phototransistor for use with the lighting system 10 is a Perkins Elmer silicon phototransistor identified as part number VTT9812FH. The photo sensor 30 may also include photo diodes and other light sensors. The photo sensor 30 preferably is independent of the housing 15, and preferably has a connector to facilitate being plugged into the circuitry 13 in the housing 15. The photo sensor 30 preferably is located remote from the lighting fixture 12 and in the area in which the lighting fixture 12 is to provide light. In alternative embodiments, the photo sensor(s) 30 may be incorporated in or part of the housing 15. The photo sensor 30 preferably supplies a dimming response signal 32 to the microcontroller 20, which corresponds to the level of light detected and received by the photo sensor 30. Preferably, the dimming response signal 32 is a voltage level between 0 and ten (10) volts, which correlates to the amount of light received on the sensor 30. Preferably, one or more photo sensors 30 are in operational association with or connected to each lighting fixture 12, or each microcontroller 20 for each lamp driving circuit 25, to permit individualized control of each lighting fixture 12 depending upon the lighting conditions at that lighting fixture 12.

The photo sensor(s) 30 are connected to the circuitry 13, preferably to the microcontroller 20 in the housing 15, and preferably provide signals 32, 33 to the microcontroller 20 that correlates with the lighting level so that the lamp driving circuit 25 and/or lighting fixture 12 can provide a dimming function whereby the power supplied to the lamps 27, and the amount of light provided by the lamps 27 and/or lighting fixture 12 can be varied depending upon the lighting conditions. Preferably, the signal 32 provided by the photo sensor 30 and the processing performed by the microcontroller 20 are such that the lighting conditions and brightness in the area of the lighting fixture 12 are not changed, but rather as light is increased in the area or room by sources other than the light fixture 12 (e.g., sun light), the artificial light supplied by the lamps 27 and/or lighting fixture 12 is dimmed That is the light created by the lamps 27 and/or lighting fixture 12 is replaced by other sources of light, such as, for example, sunlight. Likewise, when the light supplied by sources other than the lighting fixture 12 decrease, the light supplied by or the brightness of the lighting fixture 12 is increased.

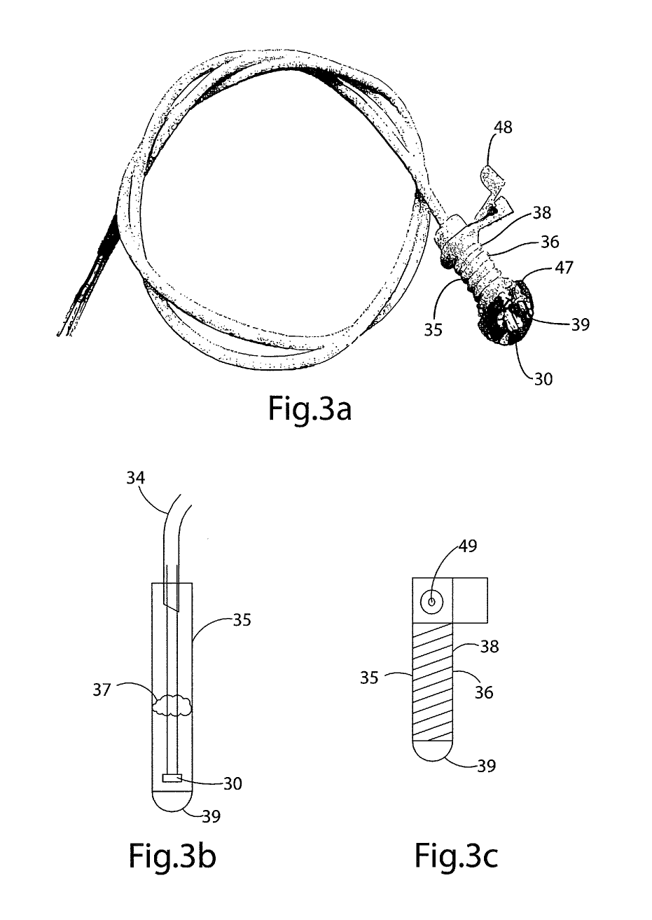

To facilitate ease of use, the photo sensor 30 may be supplied in a housing 35 as shown in FIGS. 3a, 3b and 3c. The housing 35 may be approximately 8 mm in diameter and about 40 mm in length. Other dimensions for housing 35 are contemplated, particularly a smaller low profile housing 35. The photo sensor 30 is connected to plenum rated cable 34 that is inserted down the hollow photo sensor housing 35. The housing 35 and cable 34 permit the photo sensor 30 to be mounted remote from the lighting fixture 12 but preferably in proximity to the lighting fixture. The cable 34 is preferably about one to about two feet in length, although other lengths are contemplated and will work. Packing 37 as shown in FIG. 3b stabilizes the photo sensor 30 in housing 35 and preferably prevents wires in the cable 34 from crossing or shorting out. The housing 35 may have thread(s) 36 formed on its exterior surface 38 to facilitate fastening to a structure, such as, for example, a ceiling tile in proximity to the lighting fixture 12.

While the photo sensor housing 35 and the lighting fixture 12 have been described as having one photo sensor 30, multiple photo sensors 30 and/or multiple photo sensor housings 35 maybe supplied for use with each lighting fixture 12, microcontroller 20 or lamp driving circuit 25. The use of multiple sensors 30 in multiple housings 35 permit more than one location within an area or room to be checked for lighting levels and may provide more flexibility and control. As an alternative option to the photo sensor housing shown in FIGS. 3a and 3b, a two-piece housing with a hinge or rotating joint 49 is shown in FIG. 3c. The hinge 49 permits the housing 35 to be rotated, bent or folded to reduce the housing height. The housing 35 of FIG. 3c may be advantageous in certain mounting applications, for example, low profile architectural light fixtures.

In addition, the housing 35 may include a lens 39 on its end in proximity to the photo sensor 30. The lens 39, preferably adjacent to and in front of the light sensor 30 as shown in FIG. 3b, processes and filters the light in the room or area of the lighting fixture 12 and delivers it to the photo sensor 30. A lens flange 47 may be provided on the lens 39 to act as a stop when installing the photo sensor housing 35. In addition, a spring clip 48 may be supplied with the photo sensor housing to facilitate mounting to structures adjacent the lighting fixture 12. The lighting system 10 may be provided with multiple housings 35 with different lens 39 on the housings 35 depending upon environmental factors regarding the size and shape of the room and the lighting fixture 12 installation. For example, a photo sensor housing 35 with a narrow angle lens 39 for applications where the lighting fixture 12 is mounted high in a room. Alternatively, a photo sensor housing 35 with a wide-angle lens 39 may be supplied for applications where the lighting fixture 12 is mounted in a low ceiling. A medium angle or wide-angle lens 39 may be supplied for typical ceiling heights of about eight (8) to ten (10) feet. Alternatively, or additionally, different photo sensors 30 with different response angles to accommodate different applications may be supplied; for example, a narrow response angle for high mount applications and a wide response angle for low mount applications.

The lighting system 10, in one embodiment, may also be supplied with photo sensors 30 where the sensitivity of the photo sensor 20 can be set for each microcontroller 20, power driving circuit 25 and/or lighting fixture 12. The ability to adjust the sensitivity level of the photo sensor 30, referred to as the photo sensor sensitivity function 28 as shown in FIG. 2, increases the flexibility and use of the lighting fixtures 12. For example, different applications use different light levels, and the sensitivity of the photo sensor 30 and how microcontroller 20 controls the power driving circuit 25 based upon the changing input from the photo sensor 30 may affect the effectiveness, acceptance and power consumption of the lighting system 10. For instance, a warehouse typically may be illuminated to an average level of about 15 foot-candle (about 150 lux), an office about 50 foot-candles, and critical assembly about 100 foot-candles. Photo sensor sensitivity can be increased and decreased to maximize energy savings without degrading lighting quality for each of these applications. In one example, by adjusting the photo sensor sensitivity a warehouse can start dimming when the room light level is around 25 foot-candles and quickly go to maximum dimming. In another example, by adjusting the photo sensor sensitivity, a lighting unit or fixture 12 in an office can start dimming at around 70 foot-candles, and go to maximum dimming over a larger range or amount of light variation, for example, at about 125 foot-candles. A lighting system 10 that has a photo sensor sensitivity function 28 where the photo sensor sensitivity may be adjusted provides the lighting system 10 greater flexibility so that it can be installed and operated in different building environments and settings, and can achieve maximum energy efficiency. The sensitivity adjustment function 28 may be set to affect all the lamps 27 controlled by the lamp driving circuit 25.

In a preferred embodiment, the sensitivity adjustment function 28 may provide three sensitivity setting although one, two or more settings are feasible. In use, the different sensitivity settings are different programs stored in the microcontroller, and the lighting fixture 12, or microcontroller associated with the photo sensor is calibrated based upon the lighting requirements for that lighting fixture. The program stored in the microcontroller may determine how to convert the signal from the photo sensor. For example, if the photo sensor provides an output of 0 to 10 volts, and the sensitivity has three levels (low, medium and high), then: for the low setting the microcontroller uses 4-10V as the maximum to minimum dimming range and 0-6V input is converted to a 0-4V output that the microcontroller compares to other input signals; for the medium setting the microcontroller uses 2-10V as the maximum to minimum range and 0-8V input is converted to 0-4V output; and for the high setting the microcontroller uses the full 0-10V as the maximum to minimum range, and 0-10V input is converted to 0-4V output. Initial setting and calibrating the sensitivity level is described in greater detail below.

In another embodiment the lighting system 10 may have a manual dimming and/or on-off input function 40 to the lighting fixtures 12. The manual dimming function 40 permits a user to personally control the lighting settings in the room or area where the lighting fixture(s) 12 are located. Manual dimming input 40 may be in the form of wall mounted dimmer or toggle switch 41 connected to the lighting fixture circuitry 13, and preferably connected as an input 42 to microcontroller 20 as shown in FIGS. 1 and 2. Alternatively or in addition, the manual dimming function 40 can be supplied as an input 42 to the microcontroller 20 by a personal computer 53 and/or by building central command 50 as will be described below.

Preferably, the manual dimming function 40 is programmed to set the maximum power threshold of the lighting fixtures 12 controlled by the switch 41. In other words, the manual dimming function 40 preferably is set so that the user can not increase the lighting above the lowest level set by any of the other lighting control inputs, such as, for example, the inputs from the photo sensor 30, the tuning function 18 described above, or inputs from building central command 50. The photo sensor, the tuning and central building command inputs can over ride the manual dimming function 40 to insure maximum energy savings. The preferred manual dimming feature 40 is beneficial when room occupants want to set the light level below the level set by the other inputs to the microcontroller 20. In one embodiment, the input signal 42 to the microcontroller 20 is 0 to ten (10) volts where the voltage signal 42 correlates with a lamp power output or brightness level. Of course, as a matter of design preference, the manual dimming function 40 can also be programmed to override one or more of the other inputs to the microcontroller 20 so that the room lighting level can be increased above the lighting level supplied by the other inputs to the microcontroller 20.

The lighting system 10 may also provide for control inputs from building central command 50 or personal computer workstation 53 as illustrated in FIGS. 1 and 2. In one embodiment, building central command 50 can perform or provide one or more building central command functions 51 represented preferably by one or more input signals 52 to the lighting fixture circuitry 13 and/or microcontroller 20. Commands or control input functions 51 from the building central command 50 or PC work station 53 may include: on-off functions, dimming functions, voluntary user reductions, maintenance functions and power utility demand response functions. Unlike other lighting systems where complete control is centrally processed, typically at central building command 50, the primary control of the lighting system 10 is determined by the one or more microcontrollers 20 associated with and located in proximity to or at each lighting fixture 12, circuit 13 and/or lamp driving circuit 25. The input signals 52 received from building central command 50 preferably will comprise input options for the microcontrollers 20 to process with other input signals to determine the most power efficient operation of the lighting fixture 12 and power the lighting fixture 12 accordingly. Preferably, all processing of control inputs will be performed in the microcontroller 20 associated with each power driving circuit 25 and/or lighting fixture 12.

To ease installation and decrease installation costs, the building central command functions 51 may include an interface communication device 55 with the lighting fixture circuitry 13 or microcontroller 20 so that independent signal lines do not have to be run or installed in the building for each lighting fixture 12, microcontroller 20 or power driving circuit 25. The interface communication device 55 facilitates signal transfer between the lighting fixture circuitry 13, preferably microcontroller 20, and building central command 50 or PC workstation 53, preferably without the need to run any hard wires between building central command 50 or PC workstation 53, and the light fixtures 12 to be controlled. In one embodiment, the communication interface device 55 may comprise a Power Line Communication (PLC) module 56 which permits communication between the building central command 50 and the microcontroller 20 through the power lines that provide power to the lighting fixture 12 without the requirement for additional hard wiring. Alternatively, the communication interface device 55 may comprise a wireless communication system such as, for example, ZigBee, Blue tooth, RFI or other wireless protocols. The lighting fixture circuitry 13 provided in the housing 15 preferably has a socket for a plug-in communication module. In this manner adapting the lighting fixture 12 and circuitry 13 to have the ability and option to communicate with the building central command 50 can be easily accomplished by plugging the communication interface device 55 into the socket provided in the circuitry 13.

The ability for building central command 50 to communicate with the lighting fixture 12 and provide control inputs 52 to the lighting fixture 12 increases the flexibility and control options provided in the lighting system 10. One control function that may be provided through central building control 50 is referred to as Demand Response. Demand Response function 60 is the ability of the lighting system 10 to react to an input from the power utility company to reduce power consumption. During peak energy demand hours, a power utility company may inform its customers to reduce energy to help prevent rolling black outs. The signal 61 from the utility company to decrease power consumption may be supplied to building central command 50 via a smart meter 62. A single or multi-point wireless access interface device or module 63 receives the meter signal 64 from the smart meter 63 and communicates via signal 65 with the building central command 50. Building central command 50 receives the signal 65 and may interpret the signal 65 to determine how much power reduction is required by building systems, including the lighting system 10. Building central command 50 transmits a demand response signal 66 through the PLC module 56 or other communication interface device 55 to the lamp circuitry 13, preferably to microcontroller 20, to implement the demand response function 60. The microcontroller 20 receives the demand response signal 66 and preferably processes the signal to determine the lowest power consumption for the lighting fixture 12 and/or lamp driving circuit to provide maximum energy efficiency. Preferably when the peak demand period is over, or when the power utility company indicates that power no longer needs to be reduced, a cancellation signal may be provided to the microcontroller, or the demand response signal 66 is changed. The microcontroller 20 preferably will process the new inputs to determine the most energy efficient setting.

In one embodiment the dimming performed by the lamp driving circuit 25 may be subject to a ramping action or fade function 70 over a predetermined time interval. The purpose of the fade or ramping function 70 is so that the change in brightness in the room preferably will not distract the occupants. For example, if the microcontroller 20 receives a Demand Response signal 66 and as a result the power supplied by the lamp driving circuit 25 to the lamps 27 is going to be decreased, the reduction in power to the lamps 27, and hence the reduction in brightness or light provided by the lamps 27 can be reduced over a period of time, for example, about 60 to about 120 seconds. Likewise, when the Demand Response signal 66 is cancelled and the brightness and amount of light supplied by the lamps 27 are to be increased, that increase in power and brightness can occur over a period of time so that the change in light level is gradual and not disruptive to the occupants. The duration of the fade function 70 and the speed at which the change in power supplied by the lamp driving circuit 25 to the lamps 27 occurs can be varied depending upon the desired result. In one embodiment, the duration of the fade is set at about 60 seconds. In other embodiments, the rate of change of power supplied by the lamp driving circuit 25 is held constant. The fade response 70 may be programmed into the microcontroller 20, and is schematically represented in FIG. 2.

In a preferred embodiment the ramping or fade function 70 is not used in the photo sensor control. Preferably, the photo sensor dimming response is directly controlled by the light in the room so that if light change is immediate (such as a cloud passing over), the dimming response is immediate. The ramping or fade function 70 is preferably only used when the dimming or brightening of the lighting fixture is done without a corresponding change in ambient room light. Alternatively, if desired, this ramping feature 70 may be applied any time the light level of the lamps 27 is to be changed in response to a change in control inputs 16 to the microcontroller 20.

In another embodiment of the lighting system 10, the light fixtures 12 and/or lamps 27 may be turned on and off by building central command 50. For example, an on or off signal 72 may be supplied to the microcontroller 20 from central building command 50 or PC workstation 53 as identified in FIG. 2. In yet other embodiments of the lighting system 10, building central command 50 can perform a maintenance function 75 and provide a maintenance-scheduling signal 76 to the microcontroller 20 as identified in FIG. 2. One or more maintenance scheduling signals 76a, 76b, 76c, etc. representing different maintenance schedules and providing different control inputs may be supplied to different microcontrollers 20. The maintenance schedule function 75 may be a timed program that is set to run by building central command 50 at set intervals (for example, daily, weekly, bimonthly, etc.) where the lighting may be operated at lower levels after main business hours for cleaning and/or maintenance.

In an embodiment of lighting system 10, a voluntary user reduction function 80 may be incorporated where the building can program its own peak period load reduction to increase efficiency and reduce lighting power consumption. The building central command may have a program to reduce lighting brightness at certain lighting fixtures 12 at certain times of the day. In practice, the building central command 50 may transmit a user reduction signal 81 to the lighting fixture 12 and preferably to the microcontroller 20 of one or more lighting fixtures 12 to reduce power consumption of certain lighting fixtures 12 positioned at predetermined locations of the building during predetermined times of the day. The microcontroller 20 will include the user reduction signal 81 as one of the control inputs to compare with other signals to determine the most economical and energy efficient mode to operate lamp-driving circuit 25. The user reduction function 80 may also be programmed to over ride any lower power inputs from the other sensors or inputs.

Lighting system 10 may also include an adaptive eye dimming function 85 as schematically represented in FIG. 2. Adaptive eye dimming function 85 reduces brightness or dims the lighting in the evening hours to take advantage of night time darkness and changes to the human eye as it adapts to a darker environment. Thus, where buildings operate at night, the lighting system 10 can dim the lighting fixtures 12 to operate at lower power levels and thus provide additional energy conservation. The adaptive eye function 85 can be run as part of a daily program whereby a signal 86 from the central building command is delivered to the lighting fixtures, and preferably to microcontroller 20 that includes the adaptive eye dimming signal 86 as one of several control inputs to be processed by the microcontroller 20. The adaptive eye-dimming feature 85 can be programmed similar to the tuning function 18 for the photo sensors 30 where power is reduced in set intervals or increments, such as for example, ten percent (10%).

A further control input for the lighting system 10 may include an occupancy sensor 45 as schematically illustrated in FIG. 1. The occupant sensor 45 can detect an occupant in the room to control the on/off function 46 of the lighting fixture 12. The occupant sensor 45 is in series with the power 48 feeding the circuitry 13 and controls the power feeding the circuitry 13 including the lamp powering circuitry 25. The occupancy sensor 45 acts as an on-off toggle switch for powering the lighting fixture 12. In one embodiment, the output from the occupancy sensor 45 is not fed to the microcontroller 20, although in other embodiments the output signal 47 from the occupancy sensor 45 may be supplied to microcontroller 20.

In lighting system 10 it would be advantageous to have self-diagnostic functions 90 to indicate when a lamp 27 or lamp driving circuit has failed. It may be particularly advantageous if those fault signals can be supplied to building central command 50 so that failures can be identified and maintenance can be performed on the identified lighting fixtures 12. Accordingly, in one embodiment the circuitry 13 can perform self-diagnostics and provide signal 91 to the microcontroller 20 whereby the diagnostics signal 93 is provided to building central command using the interface device 55 between the lighting fixture 12 and building central command 50.

A number of lighting fixtures 12 may be installed in a building according to lighting system 10 and connected with power line voltage 48 that is supplied to the building from the utility company. The power for the lighting system is also routed through the central building command 50. In the lighting system 10 shown in FIG. 1 the control inputs to the lighting fixture 12 include an occupancy sensor 45, a wall dimmer switch 41, a first photo sensor input 32, and a communication interference device 55 feeding a demand response input 66, and an on-off signal 72.

In the lighting system 10 of FIG. 2, the control inputs 16 (diagrammatically illustrated in FIG. 1) to the microcontroller 20 include the on-off signal 47 from an occupancy sensor 45, the dimming signal 42 from a manual dimmer function 40, a tuning signal 19 for the tuning function 18, a demand response signal 66 for a demand response function 60, photo sensor signals 32, 33 from two photo sensors 30, a maintenance signal 76 for a maintenance function 75, an adaptive eye signal 86 for an adaptive eye function 85, a user reduction signal 81 for a voluntary user reduction function 80, and a main on-off signal 72 from building central command. The microcontroller 20 reviews, compares and processes the multitude of control input signals 16 and chooses the most energy efficient setting for the lamp driving circuit 25. The lamp driving circuit 25 powers the lamps 27 connected to the lamp driving circuit 25 preferably according to the most energy efficient input, even where the central building command 50 inputs 52 may provide for energy and brightness levels that are larger than other inputs to the microcontroller 20.

Setting the tuning function 18 of the lighting fixture 12, microcontroller 20 and/or lamp driving circuit 25 to operate at a maximum threshold power level to prevent over lighting an area is typically performed after installation. A dipswitch may be supplied to set the maximum power supplied by the lamp driving circuit 25 to the lamps 27. Alternatively, or additionally, a remote receiver may be utilized to receive signal 19 that sets the tuning function 18 or power threshold level of the lamp driving circuit 25. The tuning input preferably is set in the microcontroller memory and used as an input to compare when selecting the most energy efficient operation for the lamp driving circuit. Where a remote receiver is used to tune the lamp driving circuit 25 and lighting fixture 12, a remote transmitter may be utilized for initial tuning. For example, an infrared receiver 97 may be supplied in the photo sensor housing 35, in the circuitry housing 15, or in the lighting fixture 12. The remote infrared receiver is preferably connected to the microcontroller 20 to store the threshold tuning value into memory. Alternatively, an infrared transceiver may be supplied to communicate signals to other lighting fixtures, a building central command 50, and/or a workstation PC 53.

Similarly, the setting of the photo sensor sensitivity function 28 is typically performed after the lighting fixtures 12 are installed. A dipswitch may be used to set the sensitivity of the photo sensor 30. Alternatively, or additionally, an infrared or other signal receiver may be utilized to receive a signal 29 that sets the sensitivity level of the photo sensor 30. The infrared or other signal receiver may be provided in the photo sensor housing 35, the circuitry housing 15 and/or the lighting fixture as well as other locations including a separate housing for the receiver. Where a signal receiver is utilized, such as an infrared receiver, a remote transmitter 98 (diagrammatically illustrated in FIG. 1) may be utilized to set the sensitivity setting for the photo sensor 30. In lighting systems where the lighting fixture or lamp driving circuit is tuned to have a maximum threshold power and/or the photo sensor sensitivity levels are set using an infrared or radio frequency receiver, it is preferred that a handheld key job transmitter 98 be used to set the initial tuning and calibration/sensitivity settings.

The sensitivity level preferably is set in microcontroller 20 and is used by the microcontroller 20 when comparing input signals to provide the control signal 21 to the lamp driving circuit 25. That is, the microcontroller 20 preferably contains several stored programs that define how the microcontroller 20 responds to changes in the voltage signal 32, 33 received from the photo sensor 30. The initial calibration and selection of the sensitivity level of the photo sensor chooses the pre-stored program in the microcontroller 20. One representative example of a microcontroller for use with the lighting system 10 is a Microchip 8 bit PIC Microcontroller.

In lighting systems 10 that utilize control inputs 52 from central building command 50 or a workstation PC 53, and particularly lamp circuitry 13 with communication ability (e.g., through PLC or wireless module), it is preferred that each lighting fixture 12 be addressable in order to identify and provide individual control signals 52 to the various fixtures 12 from building central command 50 or the PC workstation 53. To provide the most flexible lighting system, the system 10 preferably would identify each separate fixture 12. To identify each lighting fixture 12 in the lighting system 10, a unique address is provided to each lighting fixture 12. For example, each address may have four inputs including a number designation for the floor, a letter designation to identify the room location of the lighting fixture and a number designation to identify the particular lighting fixture in the room. Thus, for example, a lighting fixture may be assigned the address 3CO4 to identify the lighting fixture on the third floor, in room C, lighting fixture 4. Other address configurations are available. In lighting systems 10 that have communication ability with building central command 50, other PC work station 53 or other remote control station, the lighting fixture 12 may contain a dip switch to provide a unique address to each unit or an infrared receiver to store a unique address in one or more microcontrollers (depending upon how many microcontrollers 20 are associated with each lighting fixture), and the system may utilize a remote transmitter 98 with a display screen to address each lighting fixture, set the photo sensor sensitivity level and tune the fixture.

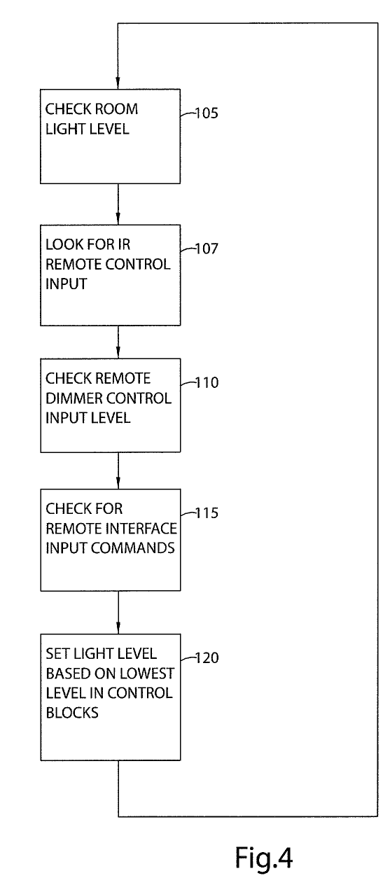

FIG. 4 is an exemplary representative control logic diagram of the control inputs 16 processed by the microcontroller 20. FIG. 4 does not illustrate all the control inputs discussed or disclosed in the application and is for explanatory purposes only. In block 105, the microcontroller 20 checks for a signal input from the photo sensor 30 and checks the current light level in the area of the sensor 30. In block 107 the microcontroller 20 checks to see if there is an infrared remote signal corresponding to the signal from an infrared transmitter used to tune the lighting fixture 12. In block 107 the microcontroller 20 also checks the value stored in memory for the tuning function 18. In block 110, the microcontroller 20 checks the manual dimming input 42 provided by, for example wall mounted dimming switch 41. And in block 115, the microcontroller 20 checks for inputs received from the communication interface device 55, preferably connected into an input socket provided in the circuitry 13 in the housing 15, for any of the various control inputs 52 that may be sent by building central command 50, such as, for example, on-off signal 72, adaptive eye function signal 86, maintenance function signal 76, demand response signal 66 and/or voluntary user reduction signal 81. In block 120, the microcontroller 20 compares the inputs 16 and sends a signal to the lamp driving circuit 25 based upon the signal corresponding to the lowest light signal received from the various inputs checked in blocks 105, 107, 110 and 115. The microcontroller 20 continuously repeats the steps in blocks 105, 107, 110, 115, and 120 of FIG. 4 and adjusts the power to the lamps 27 preferably based upon the most energy efficient operation of lighting fixture 12.

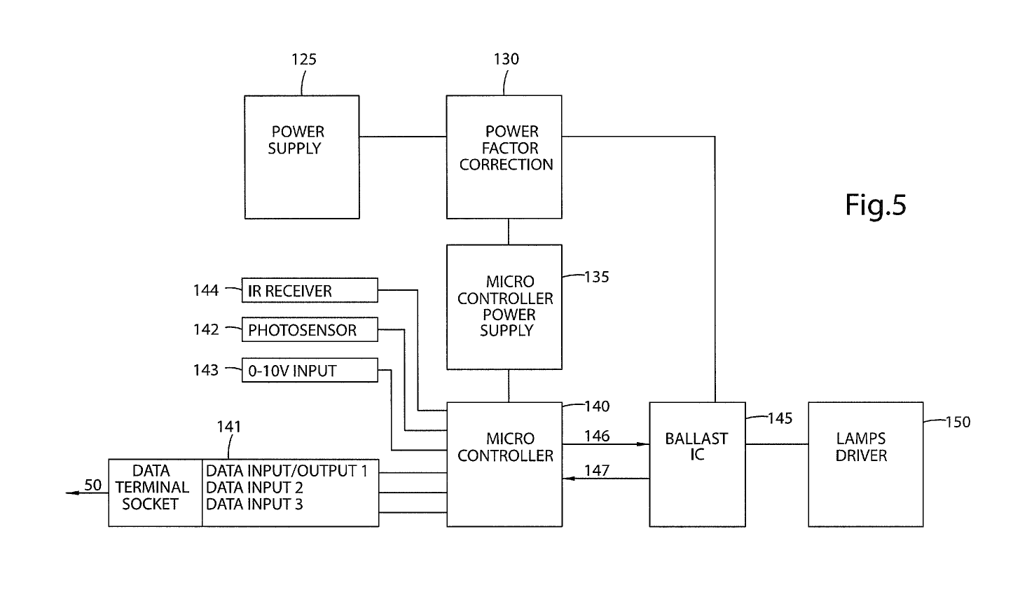

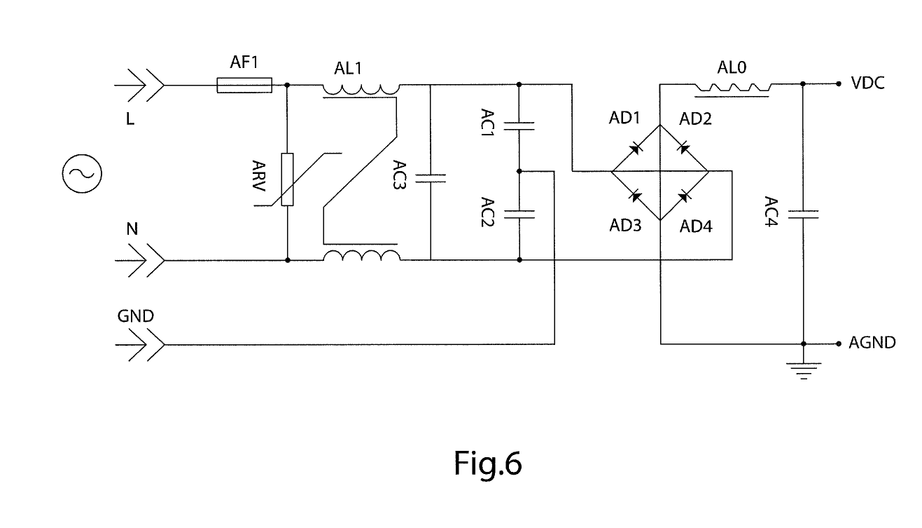

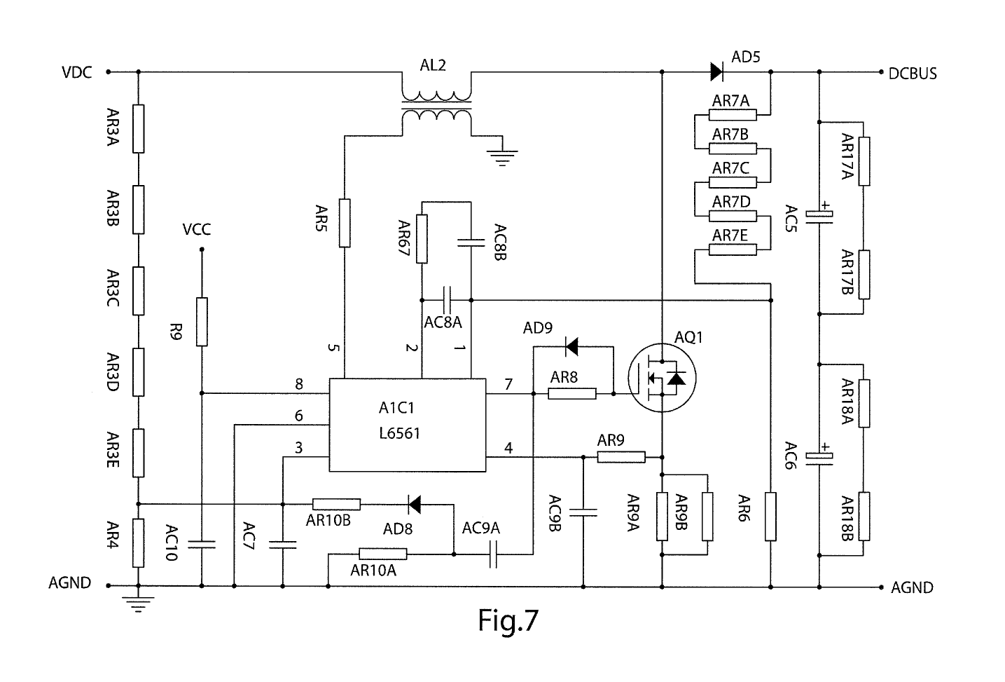

FIG. 5 shows a block diagram of the lamp control circuit 13 for the lighting fixture 12. Block 125 represents the power supply portion of circuit 13 and converts the incoming AC line power to DC power. A further preferred function of circuit 125 may be to reduce power line conducted radio interference from the ballast. FIG. 6 shows a circuit diagram of a representative and exemplary power supply circuit that may be used in the lighting fixture 12. Block 130 of FIG. 5 represents the active power factor corrector portion of circuit 13 which conditions and provides the proper voltage correction to the DC power received from the power supply circuit 125. Preferably one function of the active power factor corrector circuit 130 is to increase the ballast power input power factor to ninety percent (90%) by making the instantaneous current drawn by the ballast proportional to the instantaneous line voltage. Circuit 130 also preferably reduces odd harmonics of the 50-60 hertz line current drawn by the circuit 13. Circuit 130 also preferably delivers about 420 VDC to the ballast IC (or high frequency Inverter) circuit 145 discussed below. FIG. 7 illustrates a circuit diagram of a representative and exemplary power factor correction circuit that may be used in lighting fixture 12. The power factor circuit may use pre-regulating IC L6561 from St Microelectronics for power factor correction of the DC power supplied from the power supply. The circuit may also use L6562 from St. Microelectronics or other equivalents. The DC power from the power factor circuit represented by block 130 may be feed to the DC bus.

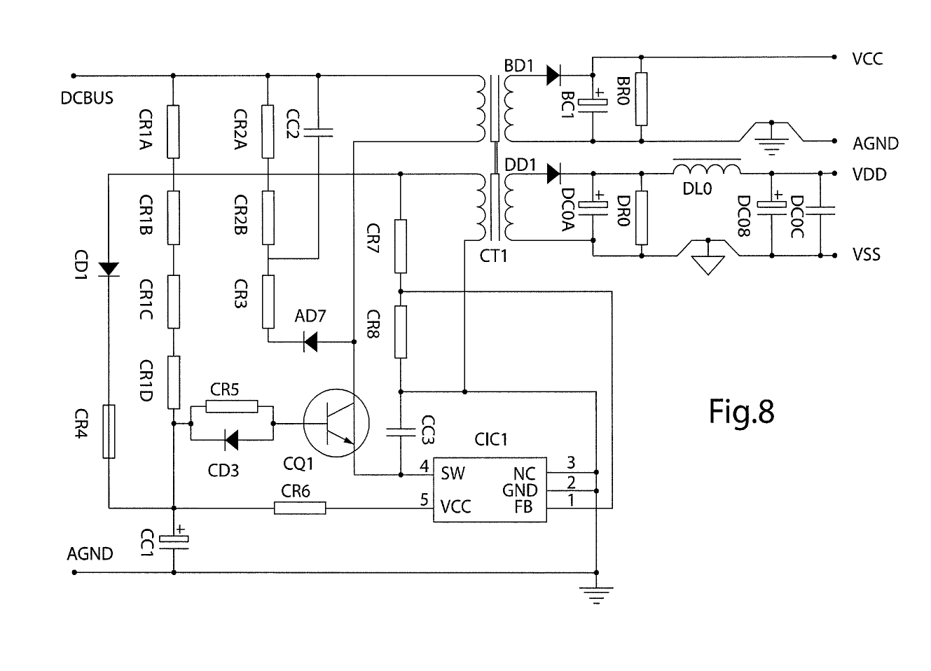

Block 135 in FIG. 5 represents the microcontroller or low voltage power supply portion of circuit 13 which serves as a dedicated power supply for the microcontroller. The purpose of circuit 135 is to insure enough power for the microcontroller to power additional inputs if required. The microcontroller will provide power for the infrared receiver and the photo sensor, and will have the potential to also power the 0-10 volt dimming source control, and the communication RFI or PLC module. The microcontroller power supply circuit 135 is optional and may not be necessary depending upon the power requirements of the microprocessor, which may depend upon the number of control inputs. For example, the communication modules (PLC or RFI module) may carry internal power supplies, in which case the standard power supply may be sufficient. FIG. 8 illustrates a circuit diagram of a representative and exemplary microcontroller power supply circuit that may be used in lighting fixture 12.

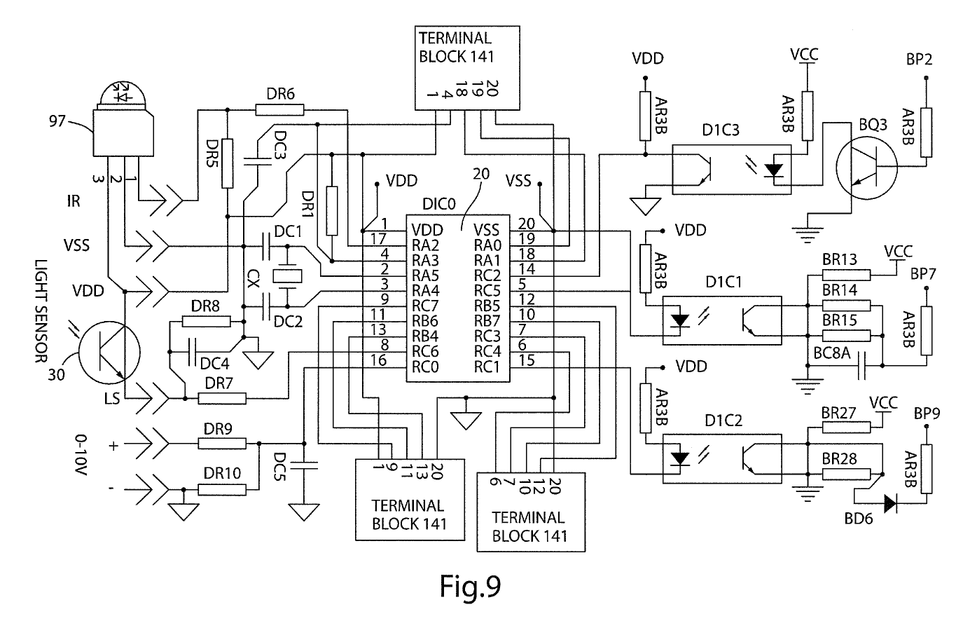

Block 140 in FIG. 5 represents the microcontroller and infrared receiver and ambient light controller portion of circuit 13, preferably located in housing 15, which is responsible for receiving all control inputs, and determining the input with the lowest energy consumption. The photo sensor input 142 and the dimming input 143 would be in the form of voltage signals, for example, 0-4 Volts. The infrared receiver input 144 and data inputs 141 preferably will be a digital signal code, although it may be an analog signal. The microcontroller is the heart of the lamp power consumption and brightness level control, and isolates and compares all control inputs including signal inputs 147 from the main ballast integrated circuit (IC) represented by block 145 (and discussed below). After interpreting the incoming voltage signals and/or signal codes, and isolating the most efficient source input (the signal that requires or represents the lowest power level), the microcontroller will send an output control voltage signal 146 to the main ballast IC represented by block 145. The data terminal socket 141 is set up to allow up to three signal input connections into the microprocessor. The data terminal socket may also permit output signals. Data terminal socket inputs may include, for example, the demand response signal 66, the adaptive eye signal 86, the voluntary user reduction signal 81, and the maintenance function signal 76 or other input signals. The microcontroller circuit 140 will also receive input signal 147 from the main ballast IC circuit 145 as part of the diagnostic and status functions (indicating a faulty lamp or ballast circuit), working as an internal interface. The information will be received from the ballast IC circuit 145, converted to data signal code, then sent to the data terminal socket 141, then to the communication interface device 55 to communicate with building central command 50 (a network control workstation 153) or building management software. FIG. 9 illustrates a circuit diagram of a representative and exemplary microcontroller circuit that may be used in lighting fixture 12.

Circuit 140 preferably performs a number of functions, which provide for automatic energy saving illumination, and may in one embodiment have the option of manual override. The circuit 140 contains four subsystems, the light sensor 30, an infrared transreceiver, the microcontroller, and the optoisolated interface. The following modes of operation achieve optimum energy savings while maintaining occupant-useful illumination. In a first mode, the light sensor 30 monitors room ambient light, and if ambient light (e.g., sunlight) exceeds a preset lumen value, the ballast output is automatically reduced to maintain the preset lumen value. The microcontroller processes the light reduction or increase needed, and signals the ballast to reduce or increase output to maintain the lumen set point via the D1C optoisolators. In the second mode, the infrared transceiver can accept an override command from a hand-held infrared remote control similar to a standard TV remote. An occupant can therefore address a specific fixture/ballast by “pointing and clicking” to set any desired lumen output from the chosen fixture/ballast.

In a third mode, building control computers at the building central command 50 (now standard in many large office and industrial buildings) serve many functions, one of which is energy consumption control, particularly during peak load times during which the electric utility company may signal the building central command to shed load or face huge peak load charges. The building central command may transmit on infrared code (wireless communication) within a given office area containing a number of lighting fixtures/ballasts. One or more of the ballasts within range of the wireless signal from the building central command preferably, depending upon design configuration and microcontroller programming, responds by reducing their lumen output and thus the power consumption. The lighting fixture that receives the signal from building central command to shed load transmits or repeats the command to reduce load to adjacent ballasts through its transceiver. The adjacent lighting fixtures complies with the command and repeats the command until all lighting fixtures within a predefined area have reduced their light output and energy consumption thus reducing load. Mode three can be programmed or configured to override mode 1 and 2, or not, depending upon user or building operator desires. In a fourth mode, an area occupancy sensor 45, such as a passive infrared or other motion sensing device can be configured to automatically dim or turn off fixtures in unoccupied rooms or areas.

While the use of simple coded infrared receivers, transmitters and transceivers provide a low cost multi-mode solution for most applications, it will be recognized by those skilled in the art that equivalent functionality can be had by the use of digitally coded radiofrequency controllers such as Bluetooth Networks or even simple 900 MHz encoded radio transceiver systems to replace or augment the infrared control scheme described herein.

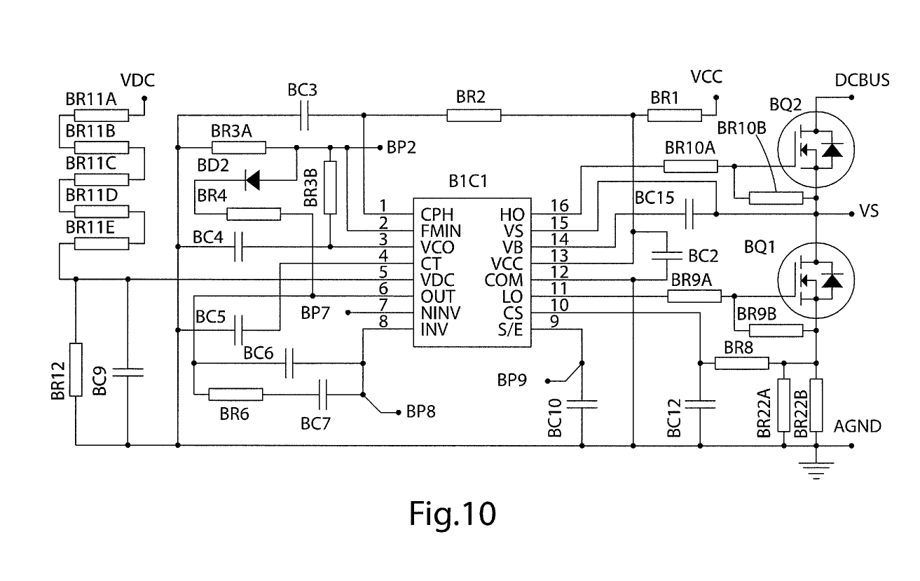

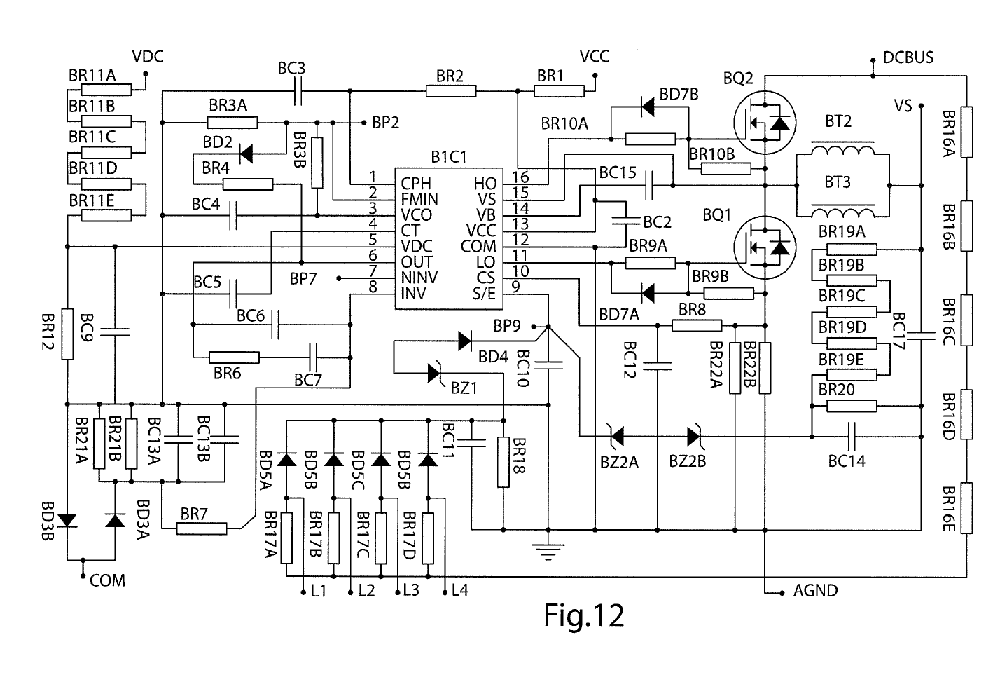

Block 145 in FIG. 5 represents the ballast integrated circuit (IC) circuit or High Frequency Inverter circuit and directly controls the start up function and operating power supply, regulates and corrects internal power design operating ranges, protects the ballast from potentially harmful fail conditions, and monitors the ballast operation status. The High Frequency Inverter Circuit preferably functions to chop down the DC power from the Active Power Factor Corrector Circuit 130 into a high frequency signal of more than 20,000 hertz. In one embodiment, a self-oscillating International Rectifier hi/lo side driver drives two mosfets to provide a 210 VAC square voltage waveform for application to the Lamp Driver and Protection Circuit 150 described below (See FIGS. 10 and 12). The ballast IC circuit 145 directly controls the dimming function of the lamp circuit, based upon input voltage signal 146 received from the microcontroller 20. The ballast IC circuit 145 may receive voltage input from the microcontroller as control signal 146, but the ballast IC is powered by the DC bus. FIG. 10 illustrates a circuit diagram of a representative and exemplary ballast IC circuit 145 that may be used in lighting fixture 12 that has two (2) lamps 27. FIG. 12 illustrates a circuit diagram of a representative and exemplary ballast IC circuit 145 that may be used in lighting fixture 12 that has four (4) lamps 27. FIG. 10 illustrates a circuit diagram of a representative and exemplary lamp power circuit that may be used to drive two (2) lamps 27 in lighting fixture 12. Ballast IC circuit 145 may use International Rectifier IC IRS 2158D.

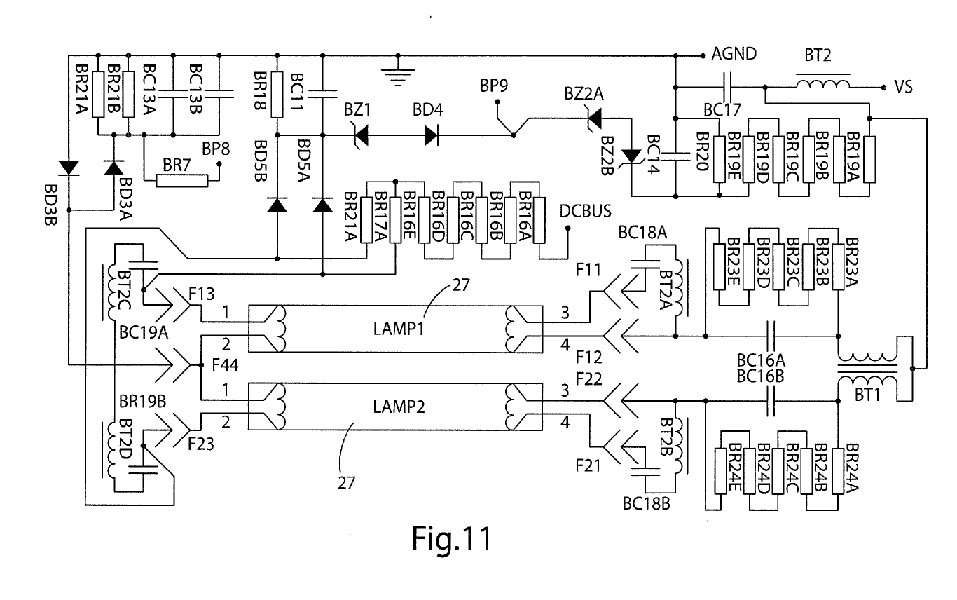

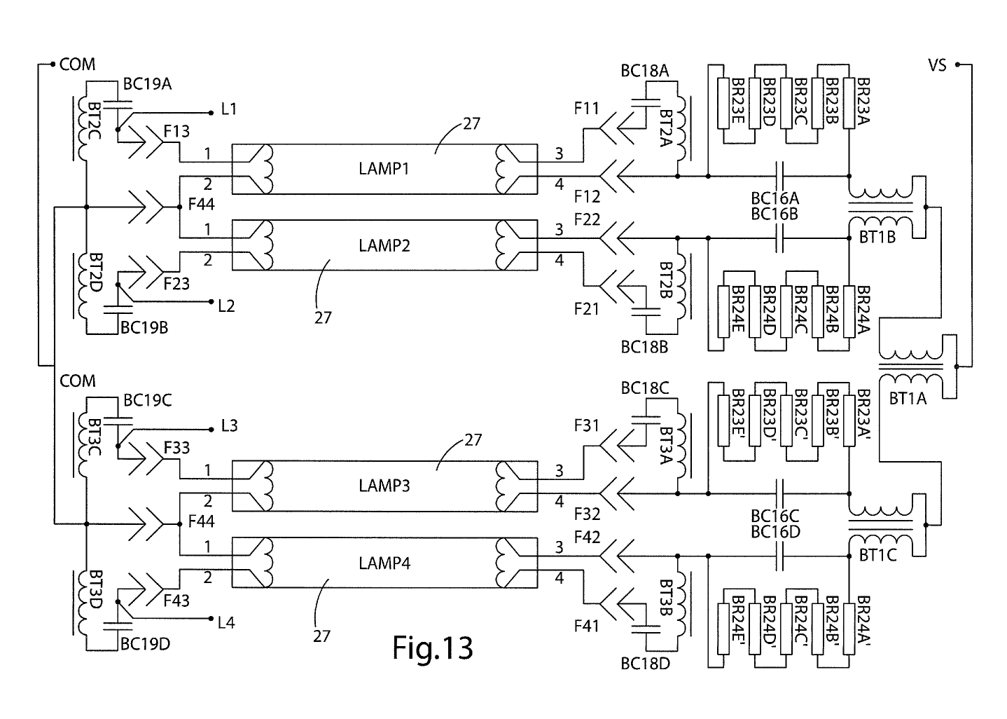

Block 150 in FIG. 5 represents the lamp driver and protection circuit and serves to condition the power and power the lamps 27 based upon the ballast IC circuit 145 input which is controlled by the microcontroller circuit 140. FIG. 11 illustrates a circuit diagram of a representative and exemplary lamp power circuit that may be used to drive two (2) lamps 27 in lighting fixture 12. FIG. 13 illustrates a circuit diagram of a representative and exemplary lamp power circuit that may be used to drive four (4) lamps 27 in lighting fixture 12.

In the embodiment shown in the circuits (FIGS. 11, 12 and 13), inductor BT2 (and BT3) and capacitor BC17 form a series resonant circuit to raise available lamp voltage during the starting phase of lamp operation. Once the lamps are ignited, the voltage across BT2/BT3 and BC17 are limited by the positive column drop across the lamps, and BT2/BT3 serves to limit current or “ballast” the lamps. The transformer windings BT2A-D (BT3A-D) function to provide proper cathode heating voltage to all two lamps in FIG. 11 and all four (4) lamps in FIG. 13 to reduce cathode fall to 11-14 volts as is conventional practice. Transformer BT2 and BT3 serve to equalize the current through each of the lamps. The remaining components comprise lamp/ballast protection; BC18/19 are prevented from charging to a high DC voltage (DCBUSS) by BR16/17 by the low resistance of cathode filaments during normal operation when these are intact. When at the end of life one or more cathodes open, the associated capacitor charges to a high voltage, turning on BD5, BZ1, and BD4 thus providing a shutdown signal at BP9. Similarly, BZ2A/B monitor the BC17/BC2 resonant voltage for excess voltage as can occur in other modes of lamp end of life, i.e., cathode emissive material wearout and unduly high lamp voltage caused thereby. If lamp voltage becomes excessive, the voltage divider BR19/20 provides a voltage which renders BRZ2A/B conductive, again raising the voltage at terminal BP9 and causing safe ballast shutdown. And BR18 and BC11 form a time constant to delay the end of life shutdown for several seconds to facilitate reliable lamp starting during which time lamp voltages are momentarily considerably higher than the highest operating voltages over the lamp life.

While the foregoing description and drawings represent the preferred embodiments of the present invention, it will be understood that various additions, modifications, combinations and/or substitutions may be made therein without departing from the spirit and scope of the present invention as defined in the accompanying claims. In particular, it will be clear to those skilled in the art that the present invention is not limited to the particular embodiments shown but may be embodied in other specific forms, structures, arrangements, proportions, and with other elements, materials, and components, without departing from the spirit or essential characteristics thereof. One skilled in the art will appreciate that the invention may be used with many modifications of structures, arrangement, proportions, materials, and components used in the practice of the invention, which are particularly adapted to specific environments and operative requirements without departing from the principles of the present invention. In addition, features described herein may be used singularly or in combination with other features. For example the functions described in the lighting system can be used singularly or in different combinations. The presently disclosed embodiments are therefore to be considered in all respects as illustrative and not restrictive, the scope of the invention being indicated by the appended claims, and not limited to the foregoing description.

We claim:

1. A lighting system for providing dimming control to at least one lighting fixture having at least one lamp comprising:
a microcontroller circuit having a microcontroller for processing a plurality of input control signals, the microcontroller circuit transmitting an output voltage control signal;
a lamp driving circuit electrically connected to the microcontroller circuit for receiving the voltage control signal transmitted by the microcontroller circuit and connectable to the at least one lamp, the lamp driving circuit responsive to the microcontroller voltage control signal to provide varying power output to the at least one lamp based upon the voltage control signal received from the microcontroller circuit; and
a power supply circuit for supplying power to the microcontroller circuit and the lamp driving circuit,
wherein the microcontroller is programmed and configured to process the plurality of input control signals and determine the output voltage control signal and transmit the same to the lamp driving circuit based upon the input control signal that would supply the lowest power output to the at least one lamp.

2. The light dimming control system of claim 1, further comprising:
a least one external communication interfacing device to facilitate communication with the microcontroller circuit, the interfacing device adapted to provide at least one input control signal to the microcontroller circuit that is external to the microcontroller circuit.

3. The light dimming control system of claim 2, wherein the communication-interfacing device comprises a module that sends signals to the microcontroller circuit over the power lines to the lighting fixture.

4. The light dimming control system of claim 2, wherein the communication-interfacing device comprises a wireless receiver for receiving signals.

5. The light dimming control system of claim 2, wherein the communication-interfacing device comprises a wireless transreceiver for transmitting and receiving signals.

6. The light dimming control system of claim 1, further comprising at least one light sensor operatively connected to the microcontroller circuit.

7. The light dimming control system of claim 6 wherein the light sensor comprises a phototransistor.

8. The light dimming control system of claim 1, further comprising at least one light sensor operatively connected to the microcontroller circuit and configured to supply a control input to the microcontroller circuit for processing.

9. The light dimming control system of claim 1, wherein the control input signals comprise at least one of the group comprising a tuning function input signal, a manual dimming input signal, a demand response function input signal, a first light sensor input signal, an occupancy sensor input signal, an adaptive eye function input signal, a maintenance function input signal, a voluntary user reduction function input signal and an on-off input signal.

10. The light dimming control system of claim 9 wherein the microcontroller is programmed to provide a fade response to a change in power supplied to the at least one lamp.

11. The light dimming system of claim 10 wherein the microcontroller is programmed so that the fade response does not apply to signals received from a light sensor input.

12. The light dimming system of claim 1 further comprising a communication interface device to communicate with a building central command, wherein the microprocessor circuit is configured to receive control signals from building central command, and further wherein the microprocessor circuit is programmed to override control signals from building central command if those signals do not provide the lowest power output to the at least one lamp.

13. The light dimming system of claim 1 further comprising a wireless receiver to receive calibration signals from a remote transmitter.

14. The lighting system of claim 13 wherein the wireless receiver comprises an infrared wireless receiver.

15. The lighting system of claim 13 further comprising a light sensor connected to the microprocessor circuit and wherein the microcontroller is configured and programmed to adjust the sensitivity of the light sensor by adjusting how the microprocessor responds to the voltage signal received by the light sensor.

16. The lighting system of claim 15 wherein the calibration signals from the remote transmitter includes signals to adjust the sensitivity of the light sensor.

17. The lighting system of claim 1 wherein the microcontroller is configured and programmed to provide a tuning calibration to set the maximum power output to be supplied to the lamps.

18. The lighting system of claim 17, further comprising a wireless receiver connected to the microcontroller circuit, wherein the wireless receiver is for supplying the microcontroller with the tuning calibration for the lighting fixture.

19. The lighting system of claim 1 further comprising a housing containing the microcontroller circuit, the lamp driving circuit, the power supply circuit and the at least one lamp.

20. The lighting system of claim 1 wherein the microcontroller circuit and lamp driving circuit are located in a housing module separate from the lighting fixture having the at least one lamp.

21. The lighting system of claim 1 wherein the microcontroller is programmed to process a signal from a building command center or remote computing device.

22. An electronic ballast system for a florescent lighting fixture comprising:
a microcontroller circuit having a microcontroller, the microcontroller circuit for processing a plurality of input controls including an input control signal from a light sensor and a remote external input control signal from a building central control, the microcontroller circuit transmitting an output voltage control signal;
a high frequency florescent lamp driving circuit electrically connected to the microcontroller circuit for powering a plurality of florescent lamps, the lamp driving circuit receiving and responsive to the voltage control signal transmitted by the microcontroller circuit to provide varying power output to the plurality of lamps;
a power supply circuit for supply power to the microcontroller circuit and the lamp driving circuit; and
a communications module for communicating with building central control for providing the input control signal from building central control to the microcontroller circuit,
wherein the microcontroller is programmed and configured to process the light sensor control signal and the external input control signal from building central control and determine the output voltage control signal and transmit that control signal to the lamp driving circuit based upon the input control signal that would provide the lowest power output to the lamps.

23. The electronic ballast system of claim 22 further comprising a wireless transreceiver, the wireless transreceiver configured and adapted to receive at least one control input signal from building central control and to transmit a signal to at least one of the group of building central control and adjacent ballast systems.

24. The electronic ballast system of claim 22 further comprising a housing containing the microcontroller circuit, the lamp driving circuit, and the power supply circuit.

25. The electronic ballast system of claim 22 wherein the microcontroller circuit and the lamp driving circuit are located in a housing module separate from the florescent lamps.

26. The electronic ballast system of claim 22 wherein the microcontroller circuit is located in a housing module separate from a housing containing the florescent lamps.

27. A controller for a lighting system comprising:
a microcontroller circuit having a microcontroller, the microcontroller circuit for processing a plurality of input controls including an input control signal from a light sensor and a remote external input control signal from a building central control, the microcontroller circuit transmitting an output voltage control signal, wherein the microcontroller is programmed and configured to process the light sensor control signal and the external input control signal from building central control and determine the output voltage control signal and transmit that control signal based upon the input control signal that would provide the lowest power output to the lamps.

28. The controller of claim 27, wherein the microcontroller is configured and programmed to process control input signals comprising at least one of the group of a manual dimming input signal, an occupancy sensor input signal, an adaptive input signal, a demand response input signal, a tuning function input signal, a maintenance function input signal, a voluntary user reduction input signal and an on-off input signal and determine the output control signal based upon the input control signal that would provide the lowest power output to the lamps.
